(19) United States
(12) Patent Application Publication
(10) Pub. No.: US 2003/0192212 A1
(43) Pub. Date: Oct. 16, 2003

(54) Dynamic display device

(76) Inventor: Kuei - Min Hsu, Taipei (TW)

Correspondence Address: BIRCH STEWART KOLASCH & BIRCH, PO BOX 747, FALLS CHURCH, VA, 22040-0747, US

(21) Appl. No.: 10/118,911

(22) Filed: Apr. 10, 2002

(51) Int. Cl. G09F 13/00; G09F 11/12

(52) U.S. Cl. 40/431; 40/472

(57) ABSTRACT

A dynamic display device includes a shell, a lens having a plurality of concave and convex portions, and a display device having two sets of one inner and one outer shaft, each set includes two shafts, mounted on a frame. An inner member and an outer pattern member are arranged on the inner and the outer shafts respectively. Each one shaft of the inner and outer shaft sets is driven by a motor through a gear set. Moreover, an illuminant is installed inside the frame. The inner and the outer pattern members are driven in opposite direction for providing changing patterns and enlarging display area.

### BACKGROUND OF THE INVENTION

1. Field of the Invention

The present invention relates to a dynamic display device, especially to an ornamental display device that includes a display device disposed inside a shell. The display device is composed of one inner and one outer shaft sets with inner and outer pattern members supported thereof respectively. The inner and outer pattern members are driven in opposite direction so as to provide changing patterns and enlarged display area.

2. Description of the Prior Art

Most of conventional display devices for household ornamentation focus on the design of lampshades. By various kinds of patterns on the lampshade, the appearance is enhanced. However, such kind of devices are static thus easy to get undesirable for users. As being disclosed in U.S. Pat. No. 5,685,097, an illuminated decorative device includes a base with a source of illumination and a drive system arranged therein, as well as a first, a second and a third translucent members surrounding the source of illumination in sequence. The first translucent member and the second translucent member have different patterns formed thereon while the third translucent member is formed with magnifying and reduction portions. When the drive system cause said first translucent member and the second translucent member to move with each other, and with respect to said base and said third translucent member, the illumination from said source of illumination as observed through said third translucent member is a changing pattern depending upon the relative positions of the three translucent members with respect to each other.

However, the three translucent members are all truncated cone-shaped so that users can only see the half of the surface area of the truncated cone. And on two sides of the eyesight, the pattern is compressed and distorted.

Moreover, the base thereof is also cylindrical thus the illuminated decorative device can only be set on a table or other planes, can't be hanged on the wall. This can't achieves the space-saving purpose.

### SUMMARY OF THE INVENTION

It is therefore a primary object of the present invention to provide a dynamic display device having a display device disposed in a shell and a lens having a plurality of concave and convex portions mounted on the front of the shell. The display device is composed of two sets of shafts with inner and outer pattern members respectively, mounted on a frame. The inner and outer pattern members move in opposite direction so as to show various patterns and enlarged display area

It is a further object of the present invention to provide a dynamic display device that has a display device disposed in a shell and a lens having a plurality of concave and convex portions mounted on the front of the shell. Thus the present invention can be hung on the wall for saving space.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is an explosive view of the present invention;

FIG. 3 is a cross-sectional view of the present invention;

FIG. 4 is a partial schematic view of the assembling of the present invention;

FIG. 5 is a partial schematic view of the assembling of the present invention.

### DETAILED DESCRIPTION OF THE PREFERRED EMBODIMENT

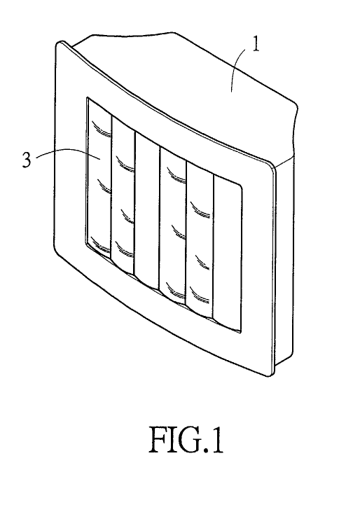

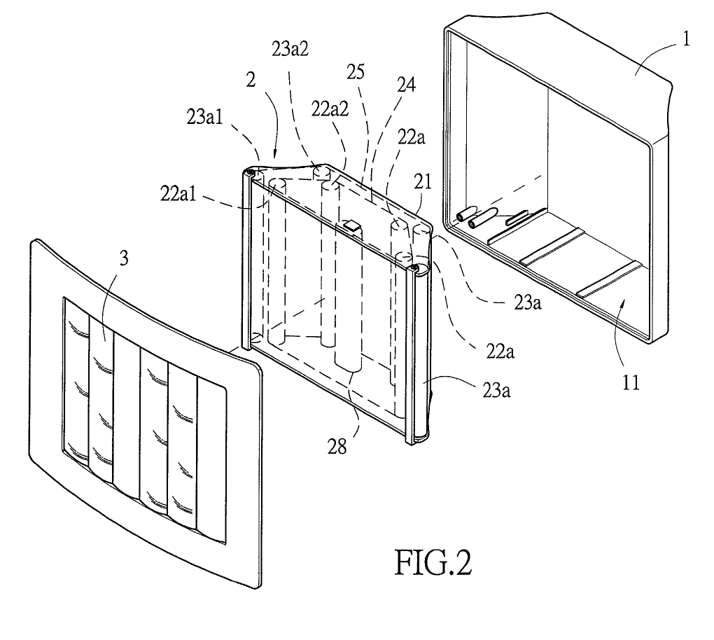

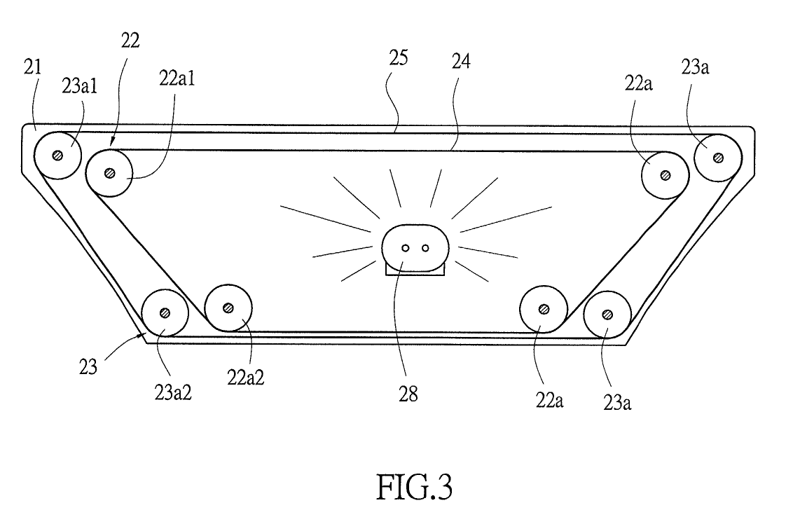

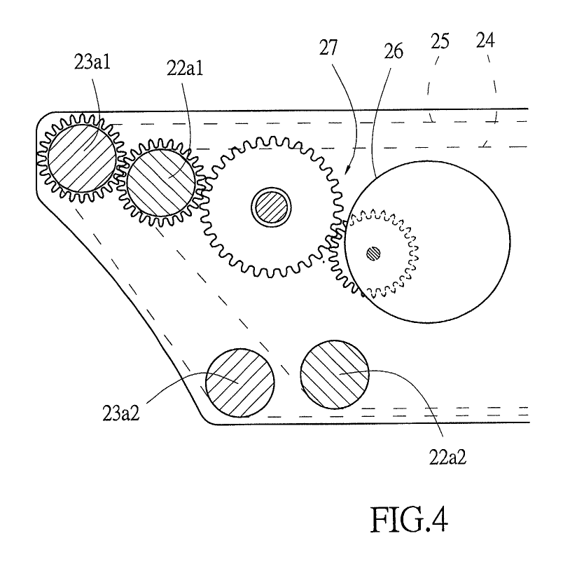

Refer to FIG. 1 & FIG. 2, the present invention comprises a shell 1, a display device 2, and a lens having a plurality of concave and convex portions3. The shell 1 is rectangular with an opening 11 on the front side thereof. The display device 2 having two shaft sets 22, 23, each with two shafts 22a, 23a, disposed on a frame 21 is mounted inside the shell 1.An inner pattern member 24 and an outer pattern member 25 are supported by the inner shaft set 22 and outer shaft set 23 respectively, as shown in FIG. 3. With reference of FIG. 4, each one shaft 22a1, 23a1 of the inner shaft set 22 and outer shaft set 23 are driven by a motor 26 through at least one gear set 27. An illuminant 28 is installed inside the frame 21, surrounding by the inner pattern member 24. Furthermore, a lens having a plurality of concave and convex portions3 is mounted on the opening 11 of the shell 1.

In accordance with the above structure, the motor 26 of the device drives the shafts 22a1 of the inner shaft set 22 and the shaft 23a1 of the outer shaft set 23 through the gear set 27 so as to make the inner pattern member24 and outer pattern member 25 circulation. The light emitted from the illuminant 28 installed inside the frame 21 of the display device 2 passes through the inner pattern member24, outer pattern member25 and the lens having a plurality of concave and convex portions3 as so to make glorious visual effect such as shimmer.

Moreover, due to the counter movement of the inner pattern member24 and outer pattern member 25, patterns thereof overlap so as to provide varying pattern of shapes.

The inner pattern member24 and outer pattern member 25 are supported by the inner shaft set 22 and outer shaft set 23 respectively thus have larger ornamental surface and obtain better visual effect.

In addition, the shell 1 of the present invention is rectangle that is easy to set on a plane or hung on the wall. Depending on the need of users, the present invention has more applications thus achieves higher practicality.

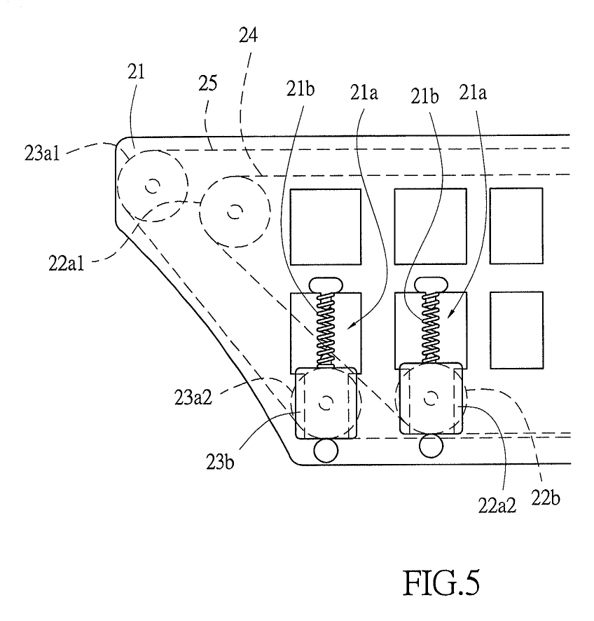

Refer to FIG. 5, the shaft 22a2 of the inner shaft set 22 and the outer shaft 23a2 of the outer shaft set 23 are pivotally disposed on slide block 22b, 23b respectively. Each slide block 22b, 23b is installed inside a runner 21a. A spring 21b is arranged between sides of the runner 21a and slide block 22b, 23b so that the shafts 22a2 and the outer shaft 23a2 tauten the inner pattern member24 and outer pattern member 25. By the movement of the shafts 22a1 and the shaft 23a1, the inner pattern member24 and outer pattern member 25 are driven through the gear set 27.

It is to be understood that the drawings are designed for purposes of illustration only, and are not intended for use as a definition of the limits and scope of the invention disclosed.

What is claimed is:

1. A dynamic display device comprising
a rectangular shell with an opening in the front side thereof,
a display device having two sets of one inner and one outer shafts, each set having two shafts, mounted on a frame, one inner and one outer pattern member housing on the inner and the outer shafts respectively, each one shaft of the inner and outer shaft sets being driven by a motor via at least one gear set, further, a luminous body installed inside the frame, the inner and the outer pattern member being able to display pattern variation with functions of mirror and enlarging display area, and
a lens having a plurality of concave and convex portions mounted on the opening of the shell.

2. A dynamic display device as claimed in claim 1, wherein each shaft of the inner shaft set and the outer shaft set are pivotally disposed on a slide block respectively, each of said slide block is installed inside a runner; a spring is arranged between said runner and said slide block in order to tauten said inner pattern member and outer pattern member.
